(19) United States
(12) Patent Application Publication
(10) Pub. No.: US 2012/0047765 A1
(43) Pub. Date: Mar. 1, 2012

(54) Helmet Accessory for Goggles

(76) Inventor: Robert Kolesar, (US)

(21) Appl. No.: 13/217,462

(22) Filed: Aug. 25, 2011

Related U.S. Application Data
(60) Provisional application No. 61/377,931, filed on Aug. 28, 2010.

(51) Int. Cl. A42B 3/04; F26B 7/00

(52) U.S. Cl. 34/442; 2/422

(57) ABSTRACT

An accessory for use in mounting and regenerating goggles while on a helmet. Features of the helmet accessory are adapted for securing the goggles, for preventing or minimizing accumulation of snow or dirt on the optical surfaces, and for removing or resisting condensation and fogging inside the goggles. The accessory includes a “face-shaped” mounting surface with nose ridge and forehead ridge configured so that the goggles may be flush seated to protect their foam edgings when sealed against the mounting surface. The mounting system is mounted on the superior front surface of the helmet and requires no modification of the goggles or helmet for use. In use, goggles may be easily transferred from a first position when worn on the user's face to a second “standby” or “regeneration” position engaging the nose and brow ridges of the face-shaped mounting system, where the goggles may be regenerated or conveniently secured when not in use.

### CROSS REFERENCE TO RELATED APPLICATIONS

This application claims the benefit of priority under 35 U.S.C. §119(e) from U.S. Provisional Patent No. 61/377,931 filed Aug. 28, 2010, which is herein incorporated in full for all purposes.

### FIELD OF THE INVENTION

The invention relates to an accessory for use with protective eye wear (such as goggles), and is an attachment for mounting eyewear on a helmet or other headgear when not in use, and may include regenerative electrical or aerodynamic features.

### BACKGROUND

Helmets for head protection are commonly combined with goggles for eye protection in sporting activities (such as snow or vehicular sports), in hazardous working conditions (such as fire protection or construction), and in military and/or police occupations.

Goggles provide eye protection both for injury prevention and to improve vision in inclement conditions. Goggles that fit snugly against the face exclude dust, other particles, and gusts of air. Eyewear of this kind is generally not readily folded or stored in the pocket because it is shaped to seal against the face of the user. It is also delicate, commonly having soft inside edgings, often made of foam, for sealingly contouring to the shape of the cheekbones, temples, nose and brow of the wearer. Most commonly the goggle is secured to the helmet by straps and/or clips.

Goggles that seal on the face have another drawback, the loss of visual clarity caused by accumulation of moisture either on the outside surfaces (usually in the form of water droplets or icing) or the interior surfaces (generally in the form of condensation or icing) of the lens. Dust and wetness can also accumulate on the internal optical surfaces when the goggles are not in use and are exposed to airflows and precipitation.

Methods for addressing these interrelated problems have been proposed but are not generally satisfactory. Poor face-to-goggle interfacing, goggle misalignment, and damage to the foam edging, for example, result from a variety of goggle retaining systems intended for clipping, securing, and/or retaining the goggles to the back, front or side of the helmet. Many helmet designs are not conducive to parking the goggles on the front brow of the helmet, resulting in the goggle and goggle strap slipping backwards along the surface of the helmet, so that at times the goggle falls off the user's head entirely. To be secure, while the goggle is parked on the front brow of the helmeted goggle user, or on a user's forehead, the goggle must rest in a manner that functionally inhibits the goggle from sliding backwards across the user's head or helmet when driven by outside forces and/or the force of the goggle's own elastic strap. Losing a pair of goggles is never good.

Loss of optical clarity is at best bothersome, and is often dangerous for the user, defeating the reason the eyewear is worn, i.e., to assure good vision in inclement conditions. Typically the wearer will remove the goggles from the eyes and raise them onto the front lip of the helmet, damaging the foam edging but allowing the interior surfaces time to dry. The goggle in this position is not sealed and also accumulates wind driven dust and debris. Many helmets are vented, so that goggles which are inadvertently placed over a helmet vent will accumulate any humidity exiting the helmet.

Obviously, moisture entering into the interior of the goggle while the goggle is parked upon the forehead or front aspect of a helmet causes fogging. In many instances, wiping out the moisture is not fully satisfactory with materials at hand, which might be a shirtsleeve, a dirty rag, or a jacket pocket lining.

Thus there is continuing need for systems to securely and/or conveniently protect the environmental integrity of the interior of a goggle, or similar type of eye protection, particularly when the goggle is parked in a standby position on the superior frontal aspect of a helmet.

Advantageously, the goggle mounting system of the invention would include means for clearing condensation and moisture (i.e., “fogging”) from the interior of the lenses when the goggle is in a standby position. Not all fogging can be prevented by sealing the goggles. Because some of the moisture that accumulates in the interior of the goggles is from sweat and tears, a system for regenerating the goggles is desirable. To be convenient, the regenerative drying system is preferably functional while the goggles are parked in a standby position on the superior front aspect of the helmet or other headgear, a natural position for this function because the goggles can be readily lifted to the standby position when regeneration is desired, and conversely can readily be lowered over to the eyes with a minimal effort when eye protection is needed.

### SUMMARY

Disclosed here is an accessory for use in mounting and regenerating goggles worn with a helmet or other headgear. The accessory includes a “face-featured,” anthropomimetic mounting surface with nose ridge and forehead ridge configured so that the goggles may be flush seated to seal and protect the foam edging when seated against the mounting surface. The mounting system is conveniently mounted on the superior front surface of the helmet, proximate to the forehead and the eyes of the wearer, and is generally detachable for maintenance or replacement.

Features of the mounting system include:
(a) an appropriately rigid but flexible, contoured mounting plate affixable to the superior front aspect of the helmet or headgear, where the plate is of sufficient size to fully engage the soft contoured, perimetrical edgings of a goggle;
(b) an anterior mounting surface of said plate, the surface large enough to enclose the perimetrical foam edging of the goggle;
(c) a forehead ridge forming a superior peripheral boundary to the anterior mounting surface; which serves to assist in guiding proper placement of the goggles and prevents the goggles from being swept back off the helmet;
(d) a nose ridge or protuberance for sealingly engaging the nose receiving channel of the goggles; where the nose ridge is modeled to conform to the molded features of the user/goggle interface;
(e) in selected embodiments, a regenerative functional element selected from heating element, aerodynamic element, air circulating element, illuminative heating element, or a combination thereof, where the regenerative element serves to assist in drying moisture from the inside surfaces of the goggles when in a standby position.
   In use, goggles may be easily transferred from a first position when worn on the user's face to a second, elevated “standby” or “regeneration” position engaging the nose and forehead ridges of a face shaped mounting system of the invention. Generally a single circumferential helmet strap may be configured for securing the goggles in either position.

In selected embodiments, the invention is a helmet:goggle interface system with “face-featured,” anthropomimetic mounting surface for resting or regenerating a pair of goggles on said helmet when not in use, which comprises a mounting plate having a) an anterior surface with a nose ridge and a forehead ridge, wherein said anterior surface is generally curved and proportioned to conform to the shape of the facially interfacing edgings of a frame of said goggles, and having a size exceeding the outside dimensions of said facially interfacing edgings of said goggles; b) a posterior surface having a negative curvature fitted for close apposition to a front-facing aspect of said helmet; and c) a means for attaching said posterior surface of said mounting plate to said front-facing aspect of said helmet. The nose ridge is configured for sealingly engaging a corresponding nose-receiving channel in the facially interfacing edgings of the goggles. The forehead ridge is formed along the superior aspect of said mounting plate and is configured for guiding and securing the goggles when mounted on the mounting plate.

Typical embodiments will comprise a regenerative system for drying or defogging a lens of the goggles, as described in more detail below. The invention is also a method for regenerating a pair of goggles, which comprises a) providing an appropriately curved, face-featured mounting plate with anterior surface upon which the goggle can be placed and/or secured, wherein said anterior surface is larger than the outside dimensions of the goggles and wherein the face-featured mounting plate is configured with a forehead ridge and a nose ridge; b) providing an actively driven or a passively driven drying system in the mounting plate; c) positioning a pair of goggles in need of regeneration on the mounting plate and actuating the drying system. The actively driven or passively driven drying system may be selected from: a) an electrical circuit with power supply for powering a heating element, wherein the power supply and heating element are combined with the mounting plate; b) an electrical circuit with power supply for powering a heating element, wherein the heating element comprises an illumination-generating element, and the power supply, heating element, and illumination-generating element are combined with the mounting plate; c) an electrical circuit with power supply for powering a fan element, wherein the power supply and fan element are combined with the mounting plate; d) an electrical circuit with power supply for powering a heating element or a fan element, wherein the electrical circuit comprises a switch that is actuated when the goggles are placed in a regenerative position on the mounting plate; e) at least one vent in the mounting plate for passively conducting airflow into or through a volume enclosed between the mounting plate and the goggles when the goggles are placed in a regenerative position on the mounting plate; or f) any combination thereof.

The foregoing and other objectives, features, and advantages of the invention will be more readily understood upon consideration of the following detailed description of the invention, taken in conjunction with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not necessarily reside in any one of these features taken alone, but rather in the claimed combination or combinations as a whole.

### BRIEF DESCRIPTION OF THE DRAWINGS

The teachings of the present invention are more readily understood by considering the drawings, in which:

FIG. 1 depicts in exploded view a first embodiment of a contoured mounting plate for use in securing a pair of goggles to the superior front aspect of a helmet.

FIG. 2 shows that the goggles have been removed from the user's face and are secured in a “standby position” atop the helmet on the contours of the mounting plate.

FIG. 3 illustrates the mounting plate affixed to the frontal aspect of a helmet while the goggles are worn over the user's eyes.

FIGS. 4A through 4G are views of a first contoured mounting plate of the invention.

FIG. 5 is a perspective view of a second contoured mounting plate of the invention.

FIGS. 6A and 6B are views of a remoldeable contoured mounting plate of the invention.

FIG. 7 is a rear elevation view showing positions of Velcro tabs used to secure the mounting plate to the helmet.

FIGS. 8A, 8B and 8C schematically illustrate functional warming hardware for drying and defogging goggles when in the standby “regenerative” position. The battery is fitted to the female groove of the forehead ridge of the back side of the mounting plate.

FIGS. 9A and 9B depict conceptual views of a warming lamp circuit which also functions for illuminating the path in front of the wearer.

FIG. 10 is a simplified general circuit model for portable, battery or solar powered electrical functions supported in the mounting plate.

FIG. 11 illustrates a mounting plate with multiple vents for promoting circulation of air through and under the goggles. For simplicity, electrical warming is not shown.

FIG. 12 is a cross-sectional view through a goggle seated on a mounting plate, with schematic representation of airflows through vents in the mounting plate and through the molded sidewalls of the goggle.

FIG. 13 is a second cross-sectional view of airflows through a goggle seated on a mounting plate.

FIG. 14 is a representation of a mounting plate with vents for controlling cross-flows.

The drawing figures are not necessarily to scale. Certain features or components herein may be shown in somewhat schematic form and some details of conventional elements may not be shown in the interest of clarity and conciseness. The drawing figures are hereby made part of the specification, written description and teachings disclosed herein.

### NOTATION AND NOMENCLATURE

Certain terms throughout the following description are used to refer to particular features, steps or components, and are used as terms of description and not of limitation. As one skilled in the art will appreciate, different persons may refer to the same feature, step or component by different names. Components, steps or features that differ in name but not in function or action are considered equivalent and not distinguishable, and may be substituted herein without departure from the invention. Certain meanings are defined here as intended by the inventors, i.e., they are intrinsic meanings. Other words and phrases used here take their meaning as consistent with usage as would be apparent to one skilled in the relevant arts.

“Mounting plate” or “mounting accessory” refers to an intermediate surface for mounting a pair of goggles or other form-fitted eyewear on the superioanterior aspect of a helmet or other headwear. The mounting plates of the invention are distinct in that they include facial features that are anthropomimetic, mimicking the contours of the noseridge, brow, temples and cheekbones of a face so that artificial facial surface sealingly conforms to the understructure of the frame of the goggles. Typically the understructures of the frame of the goggles are equipped with “facially interfacing edgings” (borders that are foam padded and relatively compliant for contacting the face). These understructures or edgings are found opposite the surfaces associated with the optical lenses of the goggles and are typically molded with contours to generally conform to the features of the face of the wearer; and thus we term the mounting plates as incorporating “face-featured surfaces” for interfacing with mated features of the goggle or other form-fitted eyewear.

“Means for attaching”—includes Velcro®, adhesive and fastener systems known in the art, and equivalents thereto, as find use in attaching the mounting plate of the invention to the superiofrontal aspect of the helmet, either directly or indirectly. The mounting plate is generally cupped on its posterior aspect so as to provide close approach of two or more surfaces where attachment can be made.

A “method” as disclosed herein refers one or more steps or actions for achieving the described end. Unless a specific order of steps or actions is required for proper operation of the embodiment, the order and/or use of specific steps and/or actions may be modified without departing from the scope of the present invention.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment and may apply to multiple embodiments. Furthermore, particular features, structures, or characteristics of the invention may be combined in any suitable manner in one or more embodiments.

“Conventional”—refers to a term or method designating that which is known and commonly understood in the technology to which this invention relates.

Unless the context requires otherwise, throughout the specification and claims which follow, the word “comprise” and variations thereof, such as, “comprises” and “comprising” are to be construed in an open, inclusive sense, that is as “including, but not limited to”.

The appended claims are not to be interpreted as including means-plus-function limitations, unless such a limitation is explicitly recited in a given claim using the phrase “means for.”

### DETAILED DESCRIPTION

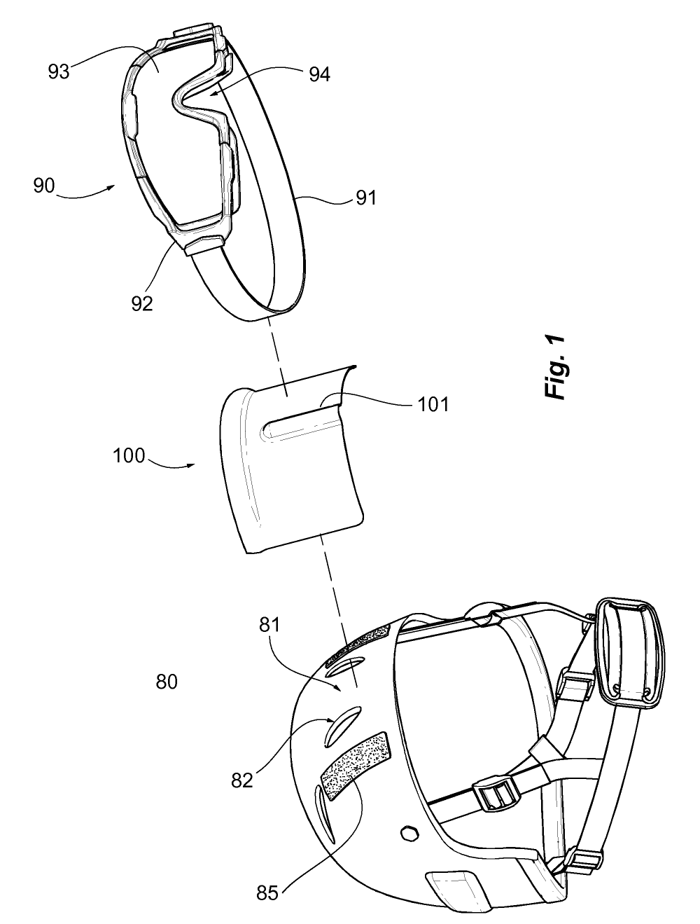

Referring to FIGS. 1 through 14, illustrated is a new and improved helmet accessory for mounting goggles, a first embodiment of which is generally denominated 100 throughout, a second embodiment denominated 200, and a third embodiment 300. Embodiments 500 and 500′ depict mounting plates with integrated regenerative hardware. Embodiments 700 and 800 depict mounting plates with ventilatory features. Other features of the inventive mounting systems are also described.

FIG. 1 is an exploded view showing a helmet (80) with superioanterior forward aspect (81) for affixedly receiving a contoured mounting plate thereon. As shown here, the mounting plate is affixed to the helmet using a Velcro fastener system, but adhesives or any suitable mechanical fastener may also be used. The mounting plate is positioned on top of any vents 82 in the helmet so that any moisture escaping from the vents in the helmet cannot enter the goggles sealed to their mounting surface. Generally the mounting plate is detachable, as is convenient for storing the helmet, for swapping out a battery on the undersurface of the mounting plate, or for general maintenance.

Goggles 90 are provided with an elastic strap or band 91 for circumferentially positioning and securing the goggles to the helmet. As shown here, the mounting plate is positioned to receive the goggles so that the goggle frame 92 does not contact the helmet. The mounting plate is provided with contoured surfaces to mate with the molded frame of the goggles, thereby providing a sealed fit between the soft underside edges of the goggles and the plate. Generally the underside edging of the goggles, which contacts the face, is formed of a soft compressible material such as a foam that conforms to the supporting surface. In this way, the inside optical faces of the lens 93 of the goggles are protected from intrusion of dirt and moisture when sealed against the mounting plate. For example, contoured surface 101, here termed the “nose ridge”, is adapted to fill and seal the nose receiving channel 94 of the goggles, as will be described in more detail below.

The helmet could be a ski helmet, a bicycling helmet, a military or fire helmet, while not limited thereto. A variety of goggles and eyewear suitable for practice of the invention are readily available and are contemplated generically here. Tabs 85 are part of a fastening system for affixing the mounting plate to the helmet, and are described below.

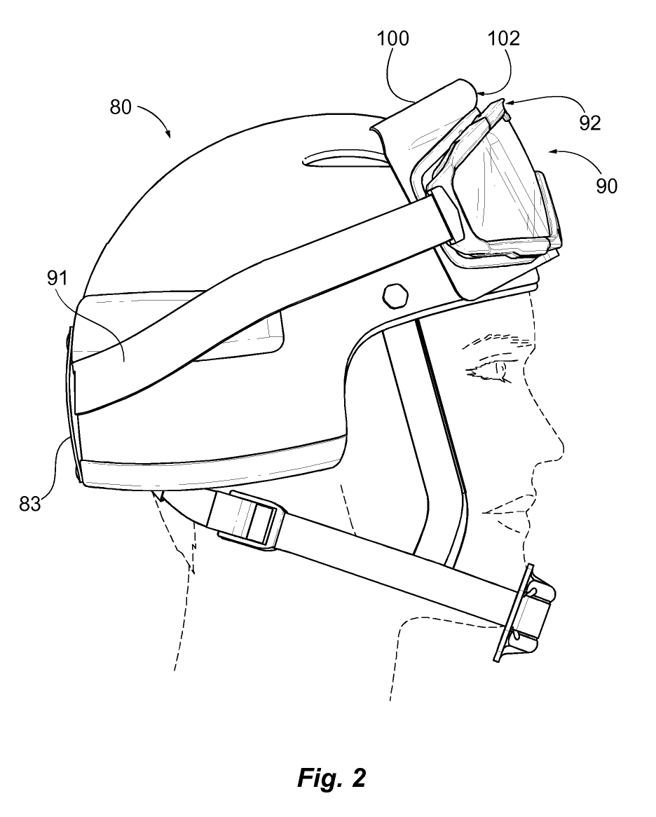

FIG. 2 demonstrates a pair of goggles 90 secured to the helmet 80 in a “standby position” atop the mounting plate. In this “standby” or “goggle regeneration” position, the goggles rest on and are mated to the contoured anterior surface of the mounting plate. The goggles are fully seated on the plate and rest against a forehead ridge 102, which is used to properly position the goggles on the mounting plate and to prevent the goggles from falling off. The mounting plate is shaped so that a seal is formed between the surface of the plate and the soft foam edge underlying the frame of the goggles. The seal is maintained by the gentle tension of the goggle strap 91. In this example, a tab 83 on the rear of the helmet 80 secures the goggle strap 91 to the helmet.

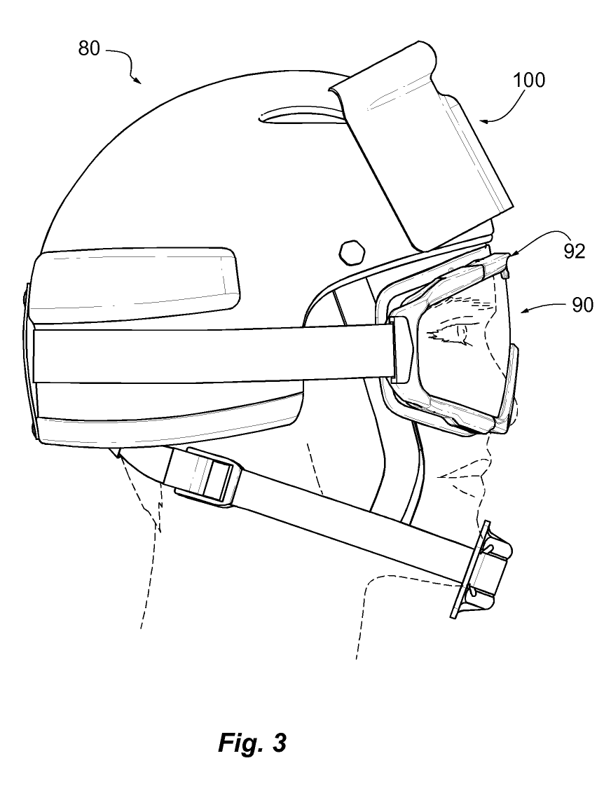

The goggles can be readily positioned in a first position over the user's eyes as shown in FIG. 3, or in a second “standby” position atop the mounting plate as shown in FIG. 2. The economy of the minimal transitional motion between the two positions may be appreciated by comparing the two figures.

When the goggles are worn over the user's eyes, the molded frame 92 of the goggles is adapted to conform to the key anatomical features of the face, the nose, temples, cheekbone, brow, forehead and jawline. The frame is edged with a soft compliant layer so as to form a seal when engaged on the face.

When the goggles are worn over the mounting plate, the contoured features of the mounting plate are configured to conform to the molded frame 92 of the goggles. The soft compliant layer edging the goggle frame forms a seal when engaged on the mounting plate, thus limiting entry of dust, snow, rain or other foreign matter. A water resistant seal is created, and the forehead ridge prevents the goggles from sliding backwards and falling off the helmet.

Since both the mounting plate and the face are similarly sculptured, the seal that is formed by the goggles is a tight seal, and there is little or no wear on the soft edging that results. In contrast, merely parking the goggles directly on the brow of the helmet results in significant fraying or ripping of the soft marginal border and fails to produce a good seal, so that water and dirt can enter, and, on the helmet's smooth plastic surface, especially when wet, the goggles are easily pulled backwards by their plastic strap and can fall off the helmet.

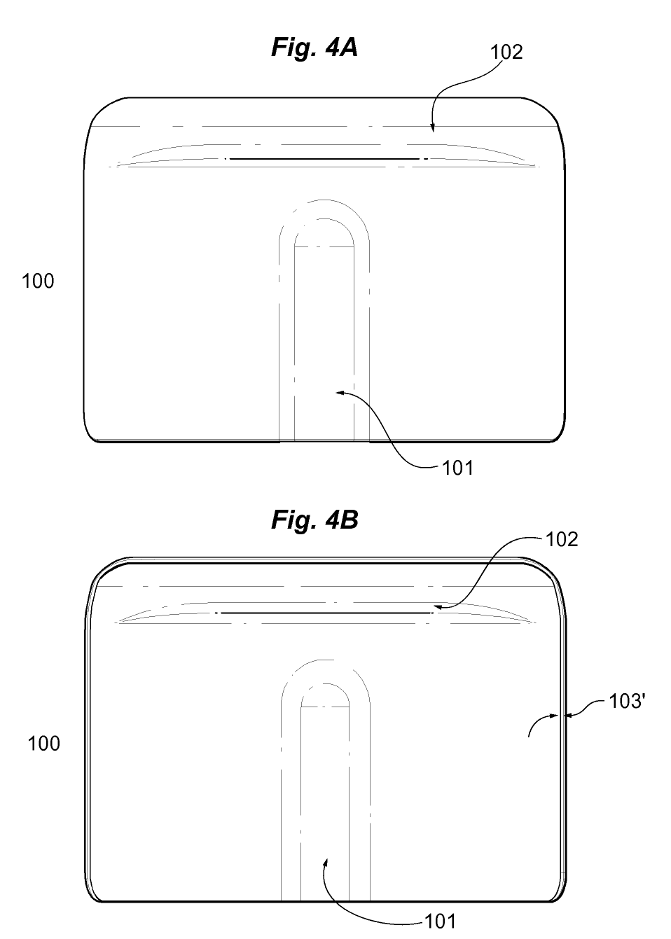

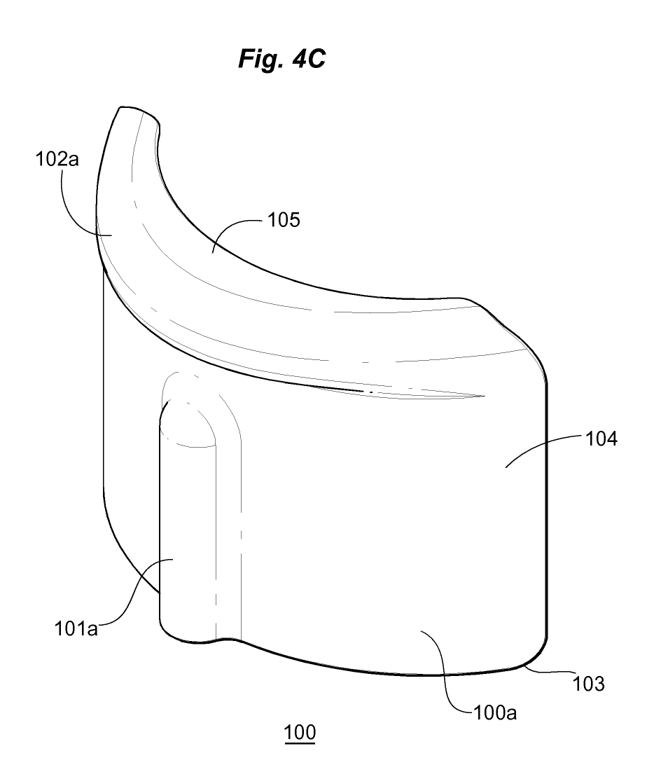

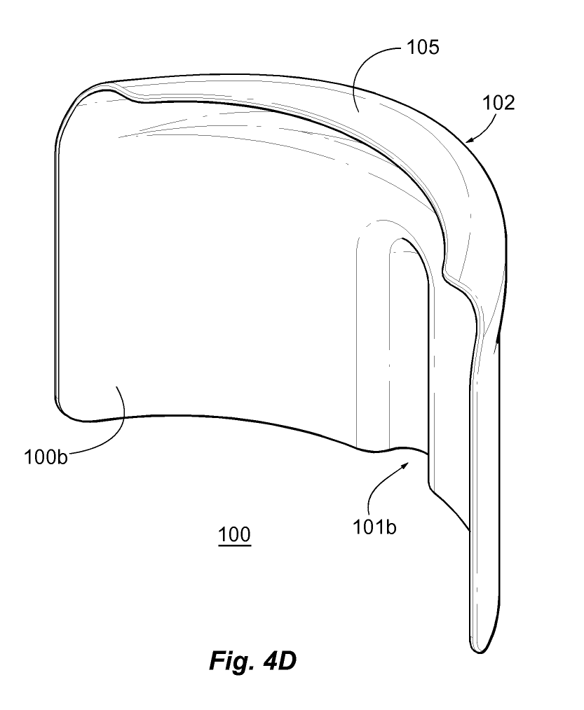

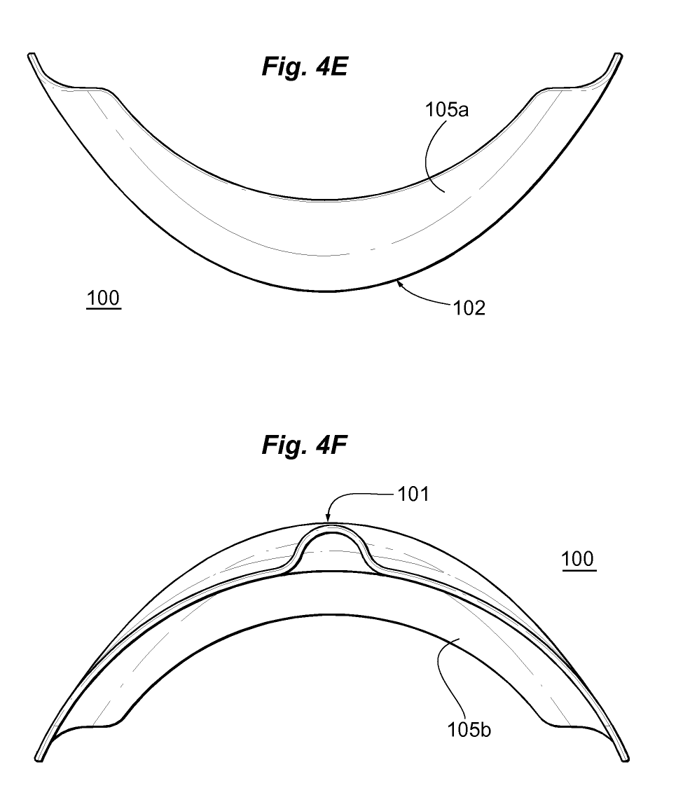

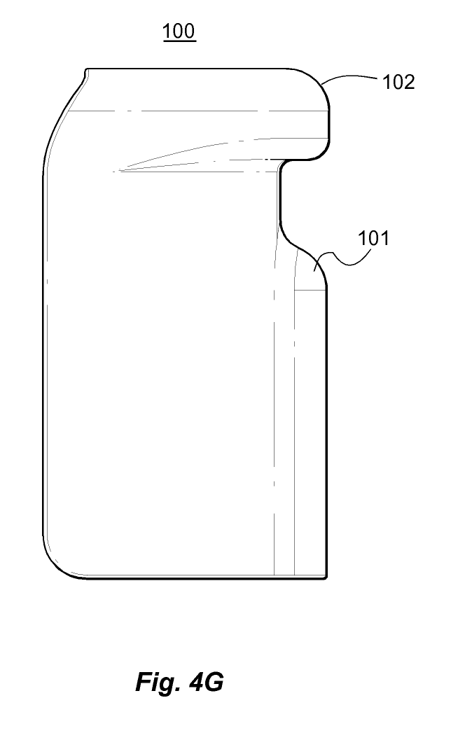

FIGS. 4A and 4B are front and back views of a first contoured mounting plate or accessory 100 of the invention. The nose ridge and brow ridge are marked as shown. In FIG. 4B, the mounting plate is shown to be molded from a thin plate. As realized in this embodiment, the plate is formed by compression molding of sheet stock. However, injection molding and vacuum forming techniques may also be used. When formed by injection molding, the three-dimensional form of the plate may have non-uniform thickness and may be formed with solid thick sections, corrugations, or hollow internal voids if desired. Generally the plate or block is formed of a plastic so as to be light, flexible and shatterproof. Shown are nose ridge 101 and forehead ridge 102. Also shown is member edge thickness 103′.

FIG. 4C illustrates the male anterior surface 100a of the mounting plate 100. Shown is a perspective view. The forward face 101a of the nose ridge extends from the lower lip 103 of the bonnet about half way or more up the front face of the “mask”, imparting a “face-like” shape to the surface. The mask curves from side to side to match the “wrap-around” shape of molded goggles, and may be flattened at the temples 104. The forward face 102a of the forehead ridge can be seen to include a ledge or cowl 105 that overhangs and extends posteriorly along the upper edge of the mask. These features are mated to corresponding features of the goggle-face interface.

FIG. 4D illustrates the female, posterior surface 100b of the mounting plate 100. A recess 101b formed by the nose ridge occupies the lower center of the mask. The uppermost overhang 105 at the top of the mask conceals a deep recess formed by the forehead ridge 102. These negative spaces may be exploited in assembling regenerative functions of the helmet accessory, as will be described below.

FIGS. 4E and 4F are top plan view and bottom views of the mounting plate 100, respectively. Shown are the outside surface of the forehead ridge 102 of the upper overhang 105a; the nose ridge structure 101 is shown here end on. The inside surface 105b of the overhanging fold 105 is also shown. Accumulation of snow under the mounting plate is prevented by the overhang 105.

FIG. 4G is a view of a first embodiment of a mask in profile. The nose ridge 101 and forehead ridge 102 are prominent in this view.

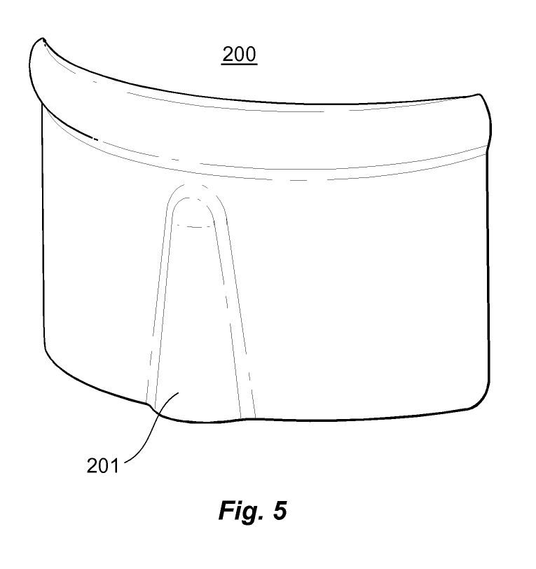

FIG. 5 is a perspective view of a second embodiment 200 of the invention. The mask is modified, having a conically flared nose ridge 201.

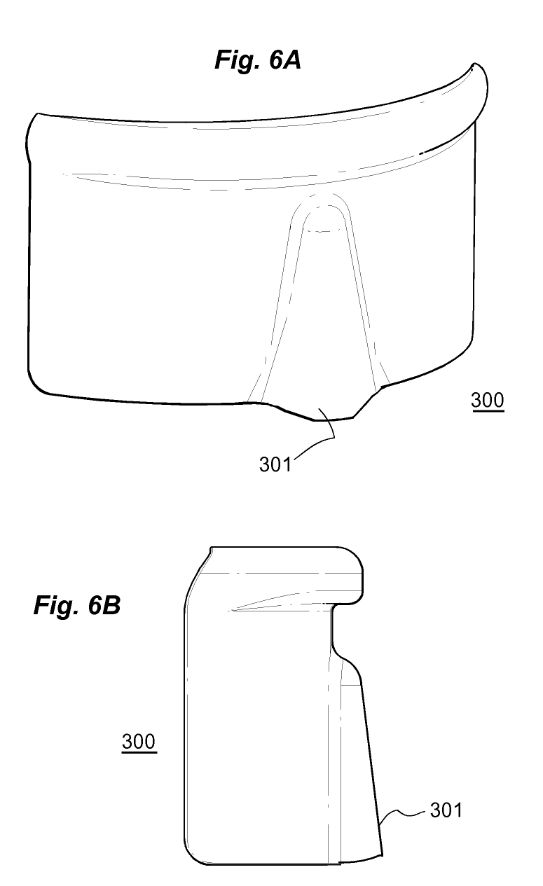

FIGS. 6A and 6B are views of a remoldeably contoured mounting accessory of the invention. Nose ridge 301 is formed of a thermoplastic that can be softened with heat and reshaped by hand to mate with a particular goggle. The topmost cowl overhang is recessed so that the curvature of the mask can also be modified if desired. FIG. 6B illustrates that the nose flare 301 has been expanded in both width and elevation.

Plastics useful for post-fabrication molding include plastics where modification of the mask contours can be accomplished with a hairblower or an oven for example. Particularly desirable for low temperature recontouring are plastics which have a glassy to rubbery transition temperature (Tg) in the range of −50° C. to about 50° C., i.e. they have good impact resistance, and melting temperatures in the range of perhaps 50° C. to 100° C. as a matter of convenience. These include for example polyethylenes and polypropylenes.

More generally, thermoplastics useful in embodiments of the invention include polyolefins, vinyls, acrylics, polyesters, polyamides, polyimides, polyethers and styrenes, among others, with or without reinforcement or fillers. These plastics are selected for their impact resistance, their resistance to shattering, and preferably have some flexibility. When selecting thermoset plastics, a desired degree of crosslinking is targeted to achieve the needed properties.

Useful for example are ABS, fiberglass, PVA, nylon, and polycarbonate, while not limited thereto, and also plastics composites. ABS mounting plates have proved durable, strong and sufficiently flexible in field trials undertaken so far.

FIG. 7 is a rear elevation view of a mounting plate showing positions of Velcro® tabs 401 used to secure the mounting plate to the helmet. The corresponding mated fastener on the helmet is shown in FIG. 1. Velcro is a convenient two part hook and loop microfastening system (U.S. Pat. No. 3,009,235), and may be adhered to surfaces using adhesives. When pressed together, a strong but detachable bond is formed. Releasable barbed fastening systems, snap-lock connectors, magnets, glues, and other fastening hardware such a screws if desired, may also be used to affix the mounting plate to the helmet. Velcro is convenient however, because the material can be applied by the end user and the bond can be detached and repositioned almost indefinitely.

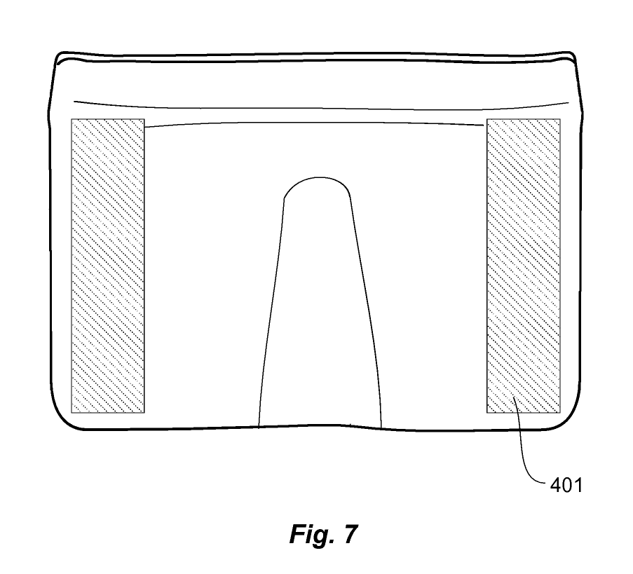

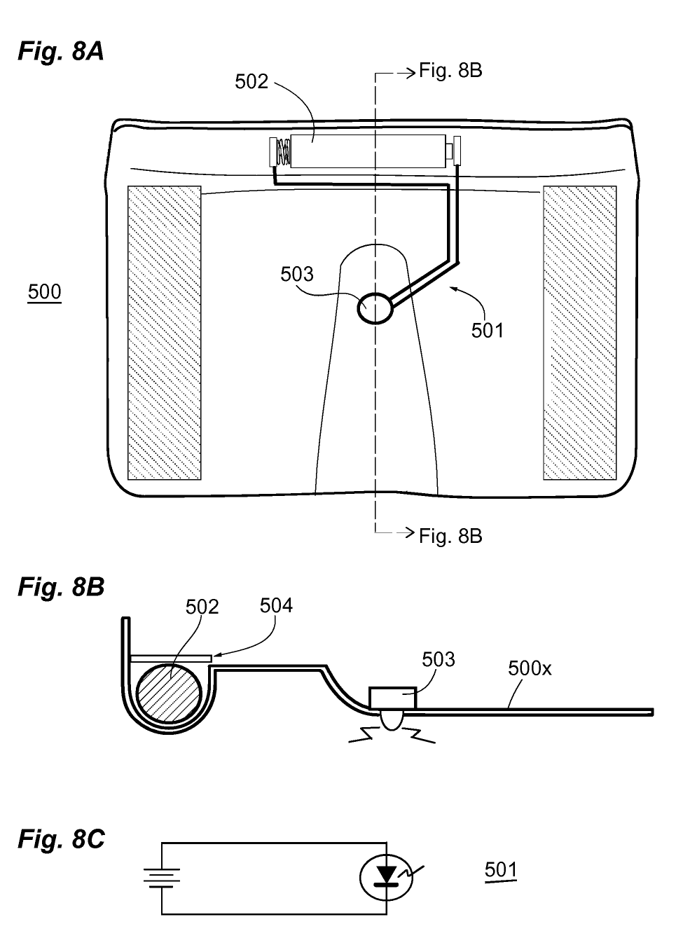

FIGS. 8A, 8B and 8C schematically illustrate functional warming hardware for drying and defogging goggle lenses when in the standby “regenerative” position on the mounting plate. Shown is a simple electrical circuit 501 with battery 502 and infrared diode with supporting integrated circuit 503. The battery is fitted to the female groove of the forehead ridge of the back side of the mounting plate. The circuitry may be weatherproofed, as with a removable coverplate 504, depicted here for illustration, or other sealable housing.

FIG. 8B depicts a cross-sectional view of a mounting plate 500 with an integrated regenerative system. The cross-section of the mounting plate is denominated as 500x. The battery 502 may be fitted into the negative space behind the forehead ridge and may be shielded with a coverplate if desired. The LED 503 and supporting circuit is fitted into the negative space behind the nose ridge, and may be sealed against weather. An on-off switch may also be provided, or a sensor for detecting the goggles in position on the mounting plate, such as an easily installed hall-effect sensor. FIG. 8C depicts a very simplified view of the circuit schematically. Optionally, multiple LEDs may be used, such as one to each side of the nose ridge as in the manner of a pair of eyes for keeping a right eye lens and a left eye lens clean and dry. Or instead of LEDs, other infrared devices may be used, such as small resistive coils or resistively etched foil appliqués.

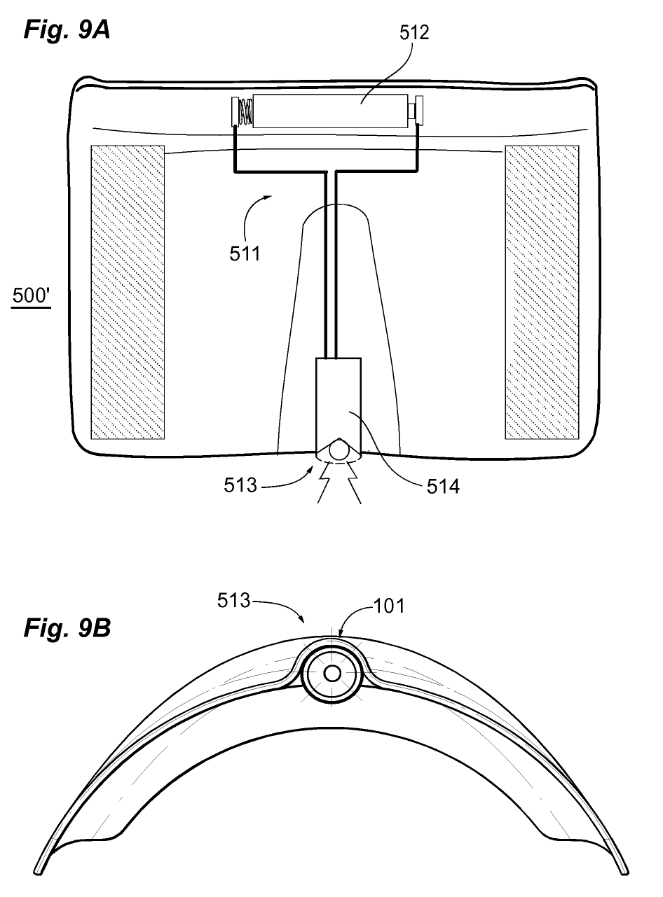

FIGS. 9A and 9B depict conceptual views of a warming circuit 511 which also functions as a lamp for illuminating the path in front of the wearer. The circuit is battery powered 512. An LED 513 optionally with strobe may be incorporated as necessary to reduce power consumption for extended use. The warmth of the lamp and the firing circuit is conductively transmitted to the goggle inside surfaces through a metal housing 514 of the circuit. The lamp includes a reflector, all of which is mounted in the negative space under the nose ridge of the device, so that illumination is directed forward and down onto the path taken by the wearer. On-off, accelerometer, or proximity sensor controls may also be included, as in an integrated circuit, for example. FIG. 9B depicts a front view of the lamp assembly 513 under the protuberance of the nose ridge 101 of the mounting plate 500′.

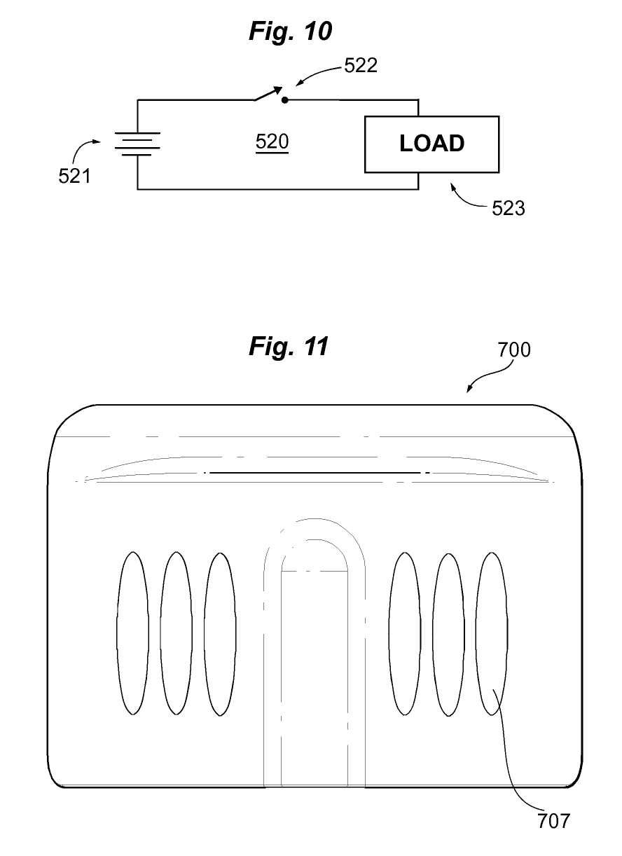

FIG. 10 is a simplified generic circuit model for portable, battery or solar powered electrical functions supported in the mounting plate 500. The circuit 520 may include one or more power supplies 521, a switch 522 that may be a finger-operated pushbutton, a toggle switch, a photosensor with flip-flop, a hall effect sensor for detecting the goggles on the mounting plate, an accelerometer, a photocell for detecting darkness, a proximity sensor, and so forth. The circuit may include an integrated circuit. The load 523 may be an infrared LED, a light, a heating coil, resistive element, or a fan, while not limited thereto. Acoustic emitters may also be provided if desired, such as a radio, a warning horn, or a beeper, any one of which also emits warmth.

FIG. 11 illustrates a mounting plate 700 with multiple vents for promoting circulation of air through and under the goggles. Shown here are six elliptical vents 707. For simplicity, electrical warming is not shown. However, vents for passively circulating airflow can be combined with warming elements to regenerate the lenses of a goggles placed on the mounting plate. Alternatively, miniature fans may be used to circulate air actively.

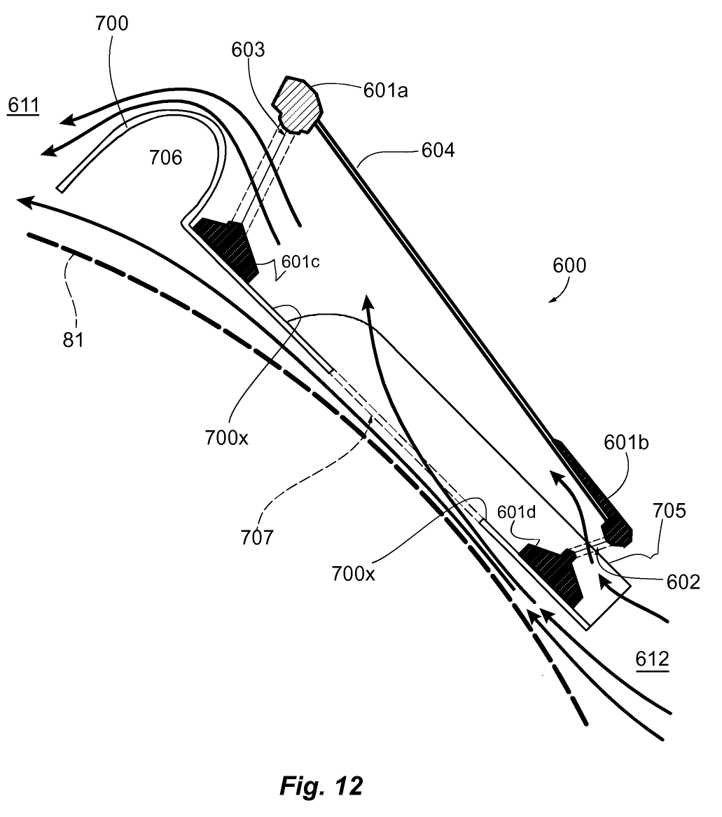

FIG. 12 is a cross-sectional view through a goggle 600 seated on a mounting plate 700, with schematic representation of passive airflows through vents in the mounting plate and through the molded sidewalls of the goggle.

Goggles 600 are often sold with a lightweight molded frame 601. Indicated are cross-sectional elements of the goggle frame denominated as 601a, 601b, 601c and 601d. These correspond in cross-section to the goggle “facially interfacing edgings.” The frame includes a lower vent 602 and an upper vent 603. Frame elements 601a and 601b are for holding lens layer 604 and elements 601c and 601d are for forming a soft compliant edging at the base of the frame and sealingly engage the face, or as shown here, the surface 700x of the face-featured mounting plate, indicated in cross-section. Also indicated (heavy dashed line 81) is the superior surface of a helmet to which the mounting plate attaches. Nose ridge 705 is indicated as out of plane of the cross-section 700x. The space formed under the forehead ridge is indicated as negative space 706. A vent 707 cut in the mounting plate is indicated by thin dashed lines.

Vents 602, 603 and 707 may be open, but more generally are faced with a lightweight hydrophobic gauze to prevent entry of particles or water while allowing circulation of air.

In passive operation, a zone of negative pressure 611 forms at the back of the forehead ridge, near the top of the helmet 81. Airflow streamlines (arrows) are drawn from the surrounding areas, including the interior of the goggles through vent 603. Replacement air is drawn into the goggles through vents 707 and 602, which helps to equilibrate humidity between the inside and outside of the goggles. The higher pressure at the front of the helmet 612 serves to push airflow along these same pathways, creating a vigorous flushing action of filtered air that assists in regenerating the goggles, particularly when combined with a warming element such as described above. Warm air is loaded with accumulated moisture from inside the goggles and is forced out through the back vents, drying the lenses and internal surfaces of the goggles. Any vents in the mounting plate are positioned to avoid interference by drawing in moisture from vents in the helmet shell.

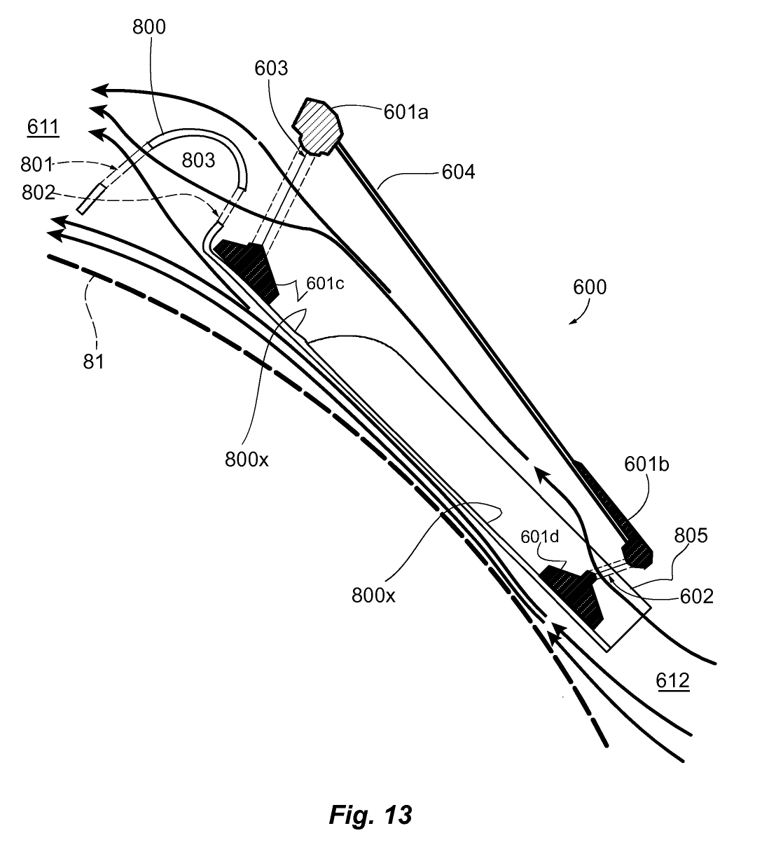

FIG. 13 is a second cross-sectional view of airflows through a goggle 600 seated on a mounting plate 800. Lightweight molded frame 601 is shown seated on a mounting plate 800x, which is shown having a thin continuous layer 800x under the goggles. The mounting plate is vented at 801 and 802. The space formed under the forehead ridge is indicated as a pocket or negative space 803. The noseridge is marked 805.

Goggle frame edging elements shown in cross-section and are denominated as 601a, 601b, 601c and 601d. The frame includes a lower vent 602 and an upper vent 603. Frame elements 601a and 601b are for holding lens layer 604 and elements 601c and 601d are for forming a soft compliant edging at the base of the frame and sealingly engage the mounting plate 800.

Airflows through the goggle and around the mounting plate are shown, indicating that the goggles can be regenerated by passive ventilation by various patterns of venting. In passive operation, a zone of negative pressure 611 forms at the back of the forehead ridge, near the top of the helmet. Airflow streamlines (arrows) are drawn from the surrounding areas, including the interior of the goggles through vents 603, 801 and 802, by the negative pressure. Filtered replacement air is drawn into the goggles through vent 602, which helps to equilibrate humidity between the inside and outside of the goggles. The higher pressure at the front of the helmet 612 serves to push airflow along these same pathways, creating a vigorous flushing action of filtered air that assists in regenerating the goggles, particularly when combined with a warming element such as described above. Warm air is loaded with accumulated moisture from inside the goggles and is forced out through the back vents, drying the lenses and internal surfaces of the goggles. Moisture exuded from vents in the helmet cannot enter the goggles in this variant because the the solid underplate 800x.

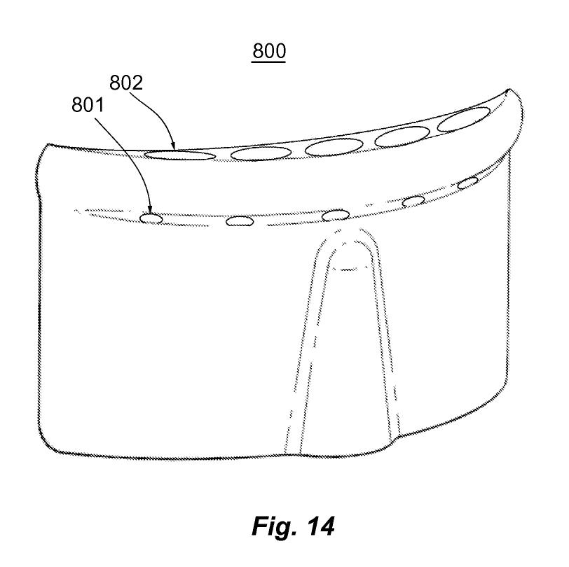

FIG. 14 is a representation of a mounting plate 800 with vents 801, 803 for controlling cross-flows through the goggles, essentially as described in FIG. 13. A design may be placed on the eye surfaces of the mounting plate to the left and right of the nose if desired.

The invention may be described in one aspect as system for securing a pair of goggles or other eyewear to a helmet or other headgear. As realized in a preferred embodiment, the system includes a stiff but generally flexible, curved and contoured, “face-featured plate”, having forehead ridge and nose ridge, which can be mounted on the front of the headgear immediately above the brow. Since the contour of the user's face around the eye sockets and across the nose will vary among goggle users, a goggle is generally designed to be flexible with soft edging on the frame that rests on the user's face and conforms to each individual's facial contour. Facial features accommodated by the frame of the goggles include the nose, the cheek bones, the temples, and the brow. Molded goggles have common features required to interface with human anatomy, and a mounting plate or surface (including a range of sizes for different users as needed) that mimics the basic three-dimensional features of a face will provide a surface on which the goggle can conform and seal. This mounting plate may thus be termed a ‘face-featured mounting plate’ or “facially contoured bonnet” or “mask” and is a useful accessory for users of helmets and goggles in combination.

The mounting plate or surface is stiff to retain its face-like contour but flexible to permit the face-featured mounting plate or bonnet for installation on a variety of helmet shapes or sizes. Additionally, the face-featured mounting plate must be somewhat larger in size than the outside dimensions of the goggle “faceprint” so that the goggle can be fully sealed against the mounting plate. Additionally, a forehead ridge is formed on the upper border of the mask, the forehead ridge for guided placement of the goggles and for securing the goggles from slipping off the mounting plate.

Optionally, a smaller ridge may be formed along the bottom of the mask, a sloped ridge along each side, and larger ridge along the top for additional slip stability in securing the goggles, but permitting the goggle to be easily moved between the standby position and the on-eyes position on the wearer's face, while assuring with the medium and larger ridges, up the sides and across the top of the mounting plate that the goggle does not slip sideways or off the top thereof. The masks are formed and sized to match goggles of different dimensions and designs if desired. As will be readily appreciated, optionally the facial features of the adaptor plate, or one or more parts thereof, may be integrated into the design of the helmet, thus forming a single-piece, monolithic helmet as an additional embodiment of the inventive helmet:goggle interface system (not shown).

In another aspect, the helmet:goggle system is a regenerative system for drying and defogging lenses that have accumulated or been misted with moisture. The regenerative system preferably operates with a combination of active and passive drying systems. These include: a) an electrical circuit with power supply for powering a heating element, wherein the power supply and heating element are combined with the mounting plate; b) an electrical circuit with power supply for powering a heating element, wherein the heating element comprises an illumination-generating element, and the power supply, heating element, and illumination-generating element are combined with the mounting plate; c) an electrical circuit with power supply for powering a fan element, wherein the power supply and fan element are combined with the mounting plate; d) an electrical circuit with power supply for powering a heating element or a fan element, wherein the electrical circuit comprises a switch that is actuated when the goggles are placed in a regenerative position on the mounting plate; e) at least one vent in the mounting plate for passively conducting airflow into or through a volume enclosed between the mounting plate and the goggles when the goggles are placed in a regenerative position on the mounting plate; or f) any combination thereof. Regeneration may be actuated by a switch for example, or merely by the action of parking the goggles in the regenerative position on the mounting plate.

Advantageously, the system also provides accessory functions such as illumination that are by-products of the regeneration system. The systems of the invention may be provided as helmet accessories and are readily attached to the helmet by the user. The mounting plates of the invention are readily detached for serving, and may be easily exchanged between helmets. Dry goggles provided by the mounting plate of the invention achieve a significant improvement in safe work and play, and the regenerative systems integrated into the mounting plate are a further advance in the art.

All of the U.S. patents, U.S. patent application publications, U.S. patent applications, foreign patents, foreign patent applications and non-patent publications referred to in this specification and related filings are incorporated herein by reference in their entirety.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims. In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited by the disclosure.

I claim:

1. A helmet:goggle interface system with face-featured anthropomimetic mounting surface for resting or regenerating a pair of goggles on said helmet when not in use, which comprises a mounting plate having
a) an anterior surface with a nose ridge and a forehead ridge, wherein said anterior surface is generally curved and proportioned to conform to the shape of the facially interfacing edgings of a frame of said goggles, and having a size exceeding the outside dimensions of said facially interfacing edgings of said goggles;
b) a posterior surface having a negative curvature fitted for close apposition to a front-facing aspect of said helmet; and
c) a means for attaching said posterior surface of said mounting plate to said front-facing aspect of said helmet.

2. The helmet:goggle interface system of claim 1, wherein the nose ridge is configured for sealingly engaging a corresponding nose-receiving channel in the facially interfacing edgings of the goggles.

3. The helmet:goggle interface system of claim 1, wherein said forehead ridge is formed along the superior aspect of said mounting plate and is configured for guiding and securing the goggles when mounted on the mounting plate.

4. The helmet:goggle interface system of claim 1, further comprising a regenerative system for drying or defogging a lens of the goggles, wherein said regenerative system is selected from:
a) an electrical circuit with power supply for powering a heating element, wherein the power supply and heating element are combined with the mounting plate;
b) an electrical circuit with power supply for powering a heating element, wherein the heating element comprises an illumination-generating element, and the power supply, heating element, and illumination-generating element are combined with the mounting plate;
c) an electrical circuit with power supply for powering a fan element, wherein the power supply and fan element are combined with the mounting plate;
d) an electrical circuit with power supply for powering a heating element or a fan element, wherein the electrical circuit comprises a switch that is actuated when the goggles are placed in a regenerative position on the mounting plate;
e) at least one vent in the mounting plate for passively conducting airflow into or through a volume enclosed between the mounting plate and the goggles when the goggles are placed in a regenerative position on the mounting plate; or
f) any combination thereof.

5. A method for regenerating a pair of goggles, which comprises:
a) providing an appropriately curved, face-featured mounting plate with anterior surface upon which the goggle can be placed and/or secured, wherein said anterior surface is larger than the outside dimensions of the goggles and wherein said mounting plate is configured with a forehead ridge and a nose ridge;
b) providing an actively driven or a passively driven drying system in said mounting plate;
c) positioning a pair of goggles in need of regeneration on said face-featured mounting plate and actuating said drying system.

6. The method of claim 5, wherein said actively driven or passively driven drying system is selected from:
a) an electrical circuit with power supply for powering a heating element, wherein the power supply and heating element are combined with the mounting plate;
b) an electrical circuit with power supply for powering a heating element, wherein the heating element comprises an illumination-generating element, and the power supply, heating element, and illumination-generating element are combined with the mounting plate;
c) an electrical circuit with power supply for powering a fan element, wherein the power supply and fan element are combined with the mounting plate;
d) an electrical circuit with power supply for powering a heating element or a fan element, wherein the electrical circuit comprises a switch that is actuated when the goggles are placed in a regenerative position on the mounting plate;
e) at least one vent in the mounting plate for passively conducting airflow into or through a volume enclosed between the mounting plate and the goggles when the goggles are placed in a regenerative position on the mounting plate; or
f) any combination thereof.
